(19) United States
(12) Patent Application Publication
(10) Pub. No.: US 2020/0220708 A1
(43) Pub. Date: Jul. 9, 2020

(54) UNITED COUNTERMEASURE AGAINST SIDE-CHANNEL ATTACKS

(71) Applicant: Kaijie WU, Lincolnshire, IL (US)

(72) Inventor: Kaijie WU, Lincolnshire, IL (US)

(21) Appl. No.: 16/239,476

(22) Filed: Jan. 3, 2019

(51) Int. Cl. H04L 9/00; G06F 21/60; H04L 29/06; H04L 9/16

(52) U.S. Cl. CPC H04L 9/002; G06F 21/602; H04L 2209/08; H04L 63/0442; H04L 9/16; H04L 63/0435

(57) ABSTRACT

This patent describes a new protocol of encryption and decryption process. With the capable of uniting all available implementations that may have different built-in countermeasures against different side-channel attacks, the patented work will have strong resistance to existing and future side-channel attacks. The limit of number of implementations, N, can be negotiated between the Sender and the Receiver, and is only limited by the resource availability (including computing, time, power, etc) of the Sender and the Receiver.

### TECHNICAL FIELD

This disclosure relates generally to information security. More particularly, it relates to cryptographic systems that encrypt, decrypt, or hash.

### BACKGROUND

A wide array of cryptographic algorithms and secure protocols are under various side-channel attacks, and new attacks are emerging each month. These attacks exploit the information leaked via the side channels of the implementations of a cryptographic algorithm or a secure protocol to recover the cryptographic keys used by the systems.

The side channels include, but not limit to, power, EM, or delay consumption of a specific implementation. For example, an uncareful implementation of a cryptographic algorithm may present noticeable different power (or time) consumption when different cryptographic keys are applied. By measuring power consumption, attackers may recover the cryptographic keys being used. Besides, the abnormal outputs produced by a specific implementation that is being intentionally abused is another type of side channel that may leak valuable information to attackers.

### SUMMARY

According to a first aspect of the present disclosure, there is provided a computer system that is capable of performing a symmetric cipher. The computer system may include one or more processors and memory storing instructions that, when executed by the one or more processors, cause the computer system to perform acts including: creating, by a sender, at least one random message using at least one random number; obtaining, by the sender, an obscured message by taking bit-wise Exclusive-OR (XOR) operations on an original message and the at least one random message; obtaining, by the sender, at least one encrypted random message by encrypting the at least one random message using at least one first secret key and using at least one first implementation of the symmetric cipher, wherein each of the least one first secret key is independent from each other and each of the at least one first implementation is unique; obtaining, by the sender, an encrypted obscured message by encrypting the obscured message by using a second secret key on a second implementation of the symmetric cipher, wherein each of the at least one first secret key and the second secret key are independent from each other, and wherein each of the at least one first implementation is different from the second implementation such that the at least one first implementation and the second implementation have different resistances to the same side channel attacks; and sending, by the sender, the at least one encrypted random message and the encrypted obscured message to the receiver.

According to a second aspect of the present disclosure, there is provided a computer system. The computer system may include one or more processors and memory storing instructions that, when executed by the one or more processors, cause the apparatus to perform acts comprising: a sender configured to: obtain an obscured message by obscuring an original message with a plurality of random numbers; encrypt each of the plurality of random numbers and the obscured message by using an independent secret key, and on one of the sender's unique implementations of the symmetric cipher; and send the encrypted random numbers and the encrypted obscured message to a receiver.

According to a third aspect of the present disclosure, there is provided a method, which may be implemented by a computer system. The method may include: creating, by a sender, N−1 messages using N−1 random numbers, wherein Nis a positive integer greater than 1; and creating, by the sender, the N^{th} message using the original message and the N−1 random numbers (the N^{th} message is hence referred to as the obscured version of the original message); and obtaining N encrypted messages by encrypting each of the N messages using an independent public key issued by a receiver, and on one of the sender's unique implementations of the asymmetric cipher.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure.

FIG. 1A is an example system according to one or more examples of the state-of-the-art technology.

FIG. 1B is an example system according to one or more examples of the state-of-the-art technology.

FIG. 2A illustrates an example system according to one or more examples of the disclosure.

FIG. 2B illustrates an example system according to one or more examples of the disclosure.

FIG. 3 illustrates an example flow chart according to the disclosed examples.

### DETAILED DESCRIPTION

The terminology used in the present disclosure is for the purpose of describing examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Reference will now be made in detail to examples, examples of which are illustrated in the accompanying drawings. The following description refers to the accompanying drawings in which the same numbers in different drawings represent the same or similar elements unless otherwise represented. The implementations set forth in the following description of examples do not represent all implementations consistent with the present disclosure. Instead, they are merely examples of devices and methods consistent with some aspects related to the present disclosure as recited in the appended claims.

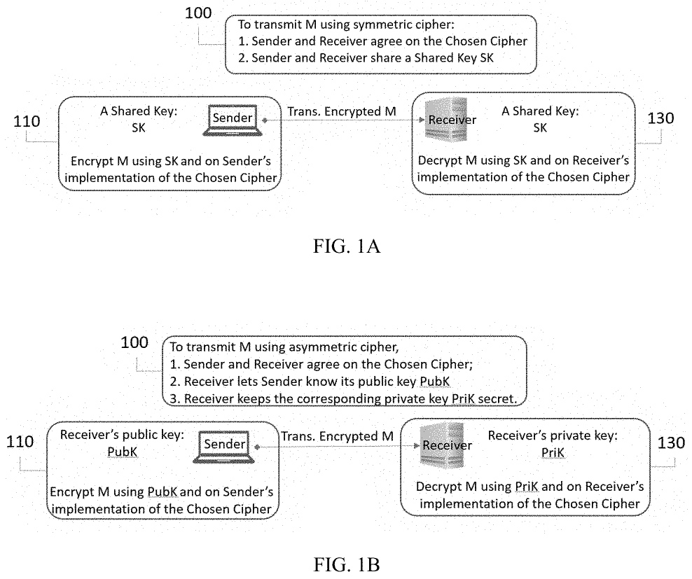

FIG. 1A is an example environment illustrating a scenario and the threat model. FIG. 1 A illustrates an example environment that uses symmetric cipher and the FIG. 1B illustrates an example environment that uses asymmetric cipher.

In FIG. 1A, a typical scenario 100 includes two communication parties, a sender 110 and a receiver 130, who want to exchange some information and don't want anybody else to know what the information is. The sender may include any electronic device including a processor and non-transitory storage accessible to the processor. For example, the sender may include one of following devices: a computer device, a server device, a laptop, a smart phone, a smart watch, and etc. The receiver may include any electronic device in communication with the sender. The receiver may include a processor and non-transitory storage accessible to the processor. Similarly, the receiver may include one of following devices: a computer device, a server device, a laptop, a smart phone, a smart watch, and etc. They choose to encrypt the message before sending and decrypt the encrypted message after receiving. Both parties agree on the cryptographic algorithm (also called cipher) that will be used for encryption and decryption and a set of cryptographic keys needed for the process. In FIG. 1A, the cipher is a symmetric cipher so both parties need to share a common secret key SK and both encryption and decryption use the SK. In FIG. 1B, the cipher is an asymmetric cipher so the receiver owns a pair of keys (PubK, and PriK) and sender can access the PubK of the receiver. The encryption is performed using PubK and the decryption is performed using PriK.

The ultimate interest of an attacker is the messages that are exchanged between the sender and the receiver. An attacker usually starts his attack before the message is exchanged. The attacker examines the encryption device used by the sender, or the decryption device used by the receiver, or both. Let's refer the device under attack as DUA. The attacker may examine all exploitable side channels of the DUA and eventually find the best channel(s) for attacking purpose. And when the sender and the receiver start their message exchange using the DUA, the attacker will obtain the information leaked via the chosen side channels and recover the key and hence the message via cryptanalysis.

Many countermeasures have been proposed to protect the security devices from these side-channel attacks. Since attacks vary significantly, most (if not all) countermeasures are customized to one specific type of attack to ensure efficiency and efficacy, and usually is incapable of the rest types of attacks. Such methodology, however, may not be sufficient in practical applications, where attackers are free to choose any types of attacks they can launch, or even a combination of attacks. If any of these attacks succeeds, the system will be broken. Since there is no way to predict which attack or a combination of attacks that attacker may launch, defenders are in a losing game. In this disclosure, a new methodology called the United Countermeasure (United-C) is provided to unify all countermeasures together to revert this game. United-C may be applied to any cryptographic system where its secret cryptographic keys are under side-channel attacks.

United-C is to greatly improve the resistance to the side-channel attacks described above and new attacks that might emerge in the future. One of the main goals of United-C is to exploit the diversity of the countermeasures that are developed to counter all known side-channel attacks. United-C works as below.

M is used to denote the message that needs encryption, which is also the interest of attackers. M could be a plaintext in an encryption process, or a ciphertext in a decryption process, or a key that is being set up during a key-exchange process. It is assumed that the sender and the receiver have negotiated the cipher that will be used for this exchange. The cipher will be denoted as the Chosen Cipher.

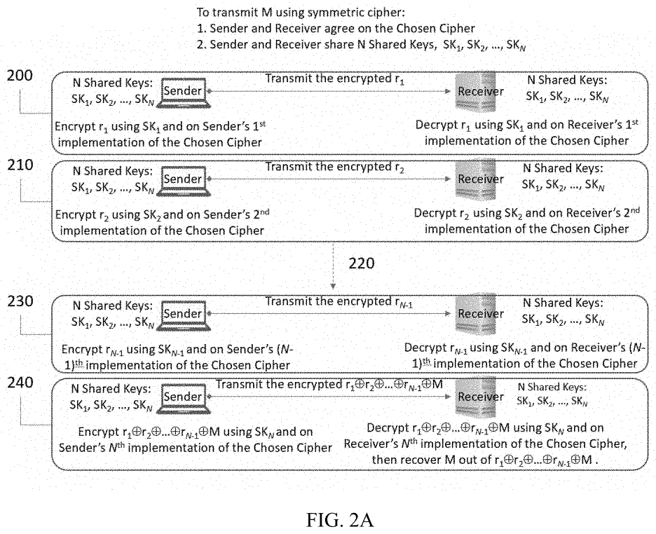

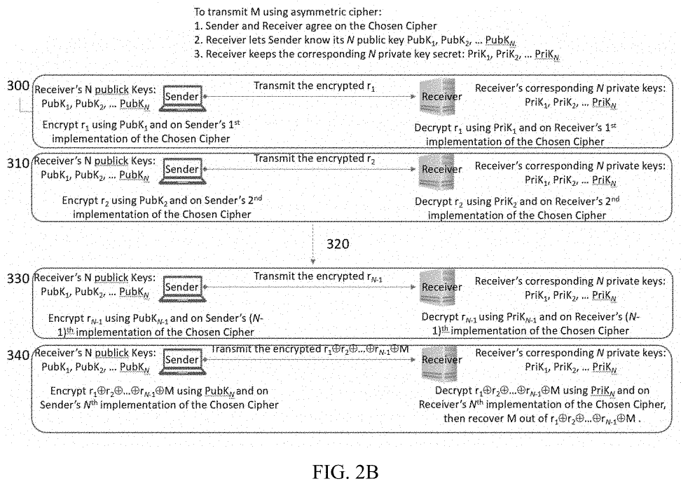

FIG. 2A illustrates an example according to one or more examples of the disclosure. FIG. 2A includes a step 200 that describes the communication of the first random number r₁. The sender encrypts the r₁ using the Chosen Cipher and the first shared secret key SK₁ and the encryption is performed by the sender's first implementation of the Chosen Cipher. The encrypted r₁ will be transmitted to the receiver, where it will be decrypted using the Chosen Cipher and the first shared key SK₁ and the decryption is performed by the receiver's first implementation of the Chosen Cipher. The step 210 describes the communication of the second random number r₂ using the Chosen Cipher and the second shared key SK₂ and by sender's and the receiver's second implementations of the Chosen Cipher, respectively. Similar procedure is carried until the last random number r_{N-1}. The step 240 describes the communication of the obscured M (i.e., M is obscured as M⊕r₁⊕r₂⊕r₃ . . . ⊕r_{N-1}) using the last shared key SK_{N} and the sender's and receiver's last implementations of the Chosen Cipher, respectively. With the knowledge of all the random numbers, r₁, r₂, . . . , r_{N-1} and the obscured M which is M⊕r₁⊕r₂⊕r₃ . . . ⊕r_{N-1}, the receiver can recover M easily.

FIG. 2B illustrates an example according to one or more examples of the disclosure. The step 300 describes the communication of the first random number r₁. The sender encrypts the r₁ using the Chosen Cipher and the receiver's first public key PubK₁ and by the sender's first implementation of the Chosen Cipher. The encrypted r₁ will be transmitted to the receiver, where it will be decrypted using the Chosen Cipher and the receiver's first private key PriK₁ and by the receiver's first implementation of the Chosen Cipher. The step 310 describes the communication of the second random number r₂ using the Chosen Cipher and the receiver's second pair of keys (PubK₂, PriK₂) and by the sender's and receiver's second implementations of the Chosen Cipher. Similar procedure is carried until the last random number The step 340 describes the communication of the obscured M (i.e., M is obscured as M⊕r₁⊕r₂⊕r₃ . . . ⊕r_{N-1}) using the Chosen Cipher and the receiver's last pair of keys (PubK_{N}, PriK_{N}), and by the sender's and receiver's last implementations of the Chosen Cipher. With the knowledge of all the random numbers, r₁, r₂, . . . , r_{N-1} and the obscured M which is M⊕r₁⊕r₂⊕r₃ . . . ⊕r_{N-1}, the receiver can recover M easily.

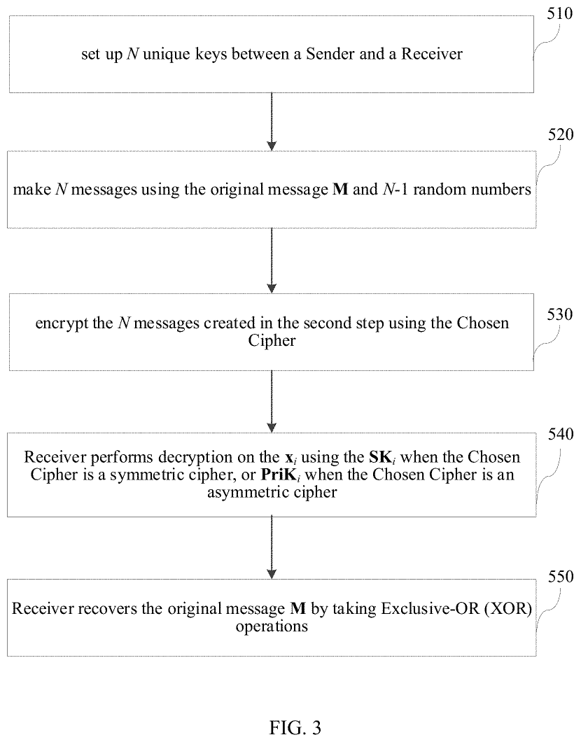

FIG. 3 illustrates an example flow chart according to the disclosed embodiments. The first step 510 of United-C is to set up N unique keys between the sender and the receiver. It could be receiver's N public-private key pairs if the Chosen Cipher is a public-key cipher (also called asymmetric cipher), or N shared secret keys if the Chosen Cipher is a symmetric cipher. For example, the secret keys may be denoted as SK₁, SK₂, . . . , SK_{N}, if the Chosen Cipher is a symmetric cipher. Alternatively, the receiver's public-private key pairs may be denoted as (PubK₁, PriK₁), (PubK₂, PriK₂), . . . , (PubK_{N}, PriK_{N}), where PubKᵢ, and PriKᵢ stand for the i^{th} pair of public key and private key, respectively. This step is common to many existing security protocol except that the existing protocols set up only one key for symmetric cipher, or one pair of public key and private key for asymmetric cipher.

The second step 520 of United-C is to make N messages using the original message M and N−1 random numbers as the follows:

The 1^{st} message is r₁, a random number.

The 2^{nd} message is r₂, a random number.

. . .

The (N−1)^{th} message is r_{N-1}, a random number. All these random numbers are generated on the fly and there is no need to save any of these random numbers in any permanent storage medium. Note that the total number of random messages between the sender and the receiver may be negotiated or adjusted based on different factors, which include locations of the sender and receiver, preset protocols between the sender and receiver. For example, when the sender and receiver are both located in the same office location, the total number may be less than a preset threshold according to a preset protocol. When only one of the sender or receiver is located in a relatively safe location such as an office while the other one is located in a relatively danger location (such as a public space), the total number may be greater than the preset threshold.

Alternatively or additionally, N may be selected by the receiver and the sender based on a frame index. For example, N may increase when the frame index increases in a certain period of time. N may also be adjusted based on a function of the frame index, where the function may include a modular arithmetic function or any other function.

Here, the N^{th} message may be the output of a reversible function F that takes all N−1 random numbers and the original message M. The reversible function F can be any function where M can be recovered if given the N−1 random numbers and the output of F. For example, F function can be simply an XOR operation, a XNOR operation, or a cascaded XOR/XNOR operation. When the reversible function F is a cascaded XOR operation, the N^{th} message is created by taking bit-wise Exclusive-OR (XOR) operations on the original message M and all the random numbers used in previous N−1 steps, that is M⊕r₁⊕r₂⊕r₃ . . . ⊕r_{N-1}, where ⊕ stands for bit-wise Exclusive-OR (XOR) operation.

Alternatively or additionally, at least some of the reversible function F can be replaced by Exclusive-NOR (XNOR) operations. Further, at least some of the random numbers or M can participate the operations either in its original form, or in any form from which its original form can be recovered (e.g., in its inverted form).

The third step 530 of United-C is to encrypt the N messages created in the second step using the Chosen Cipher. The i^{th} message will be encrypted using the i^{th} secret key SKᵢ if the Chosen Cipher is a symmetric cipher, or the public key of the i^{th} public-private key pair PubKᵢ if the Chosen Cipher is an asymmetric cipher. Each encryption can be performed by an unique implementation of the Chosen Cipher, and at most N unique implementations of the Chosen Cipher are needed by the Sender. Knowing that different implementations may have different countermeasures built-in, and hence may differ significantly in their resistance to different side-channel attacks, the sender can choose his own set of N implementations based on the evaluation of the potential threats on his end. The each unique implementation implements the chosen cipher with its unique approach and thus leaks unique side-channel information in a potential side channel attack. In other words, the each unique implementation has a unique resistance to the same side channel attacks. Here, the output of encrypting the i^{th} message is denoted as xᵢ. The following shows the correspondence between messages, keys, and their outputs:

When the Chosen Cipher is a symmetric cipher:
Encrypt r₁ using SK₁ on the Sender's 1^{st} implementation of the Chosen Cipher,

output x₁;

................... ...continue the following pattern... ... ... ... ... ... ... ... ... .....
Encrypt rᵢ using SKᵢ on the Sender's i^{th} implementation of the Chosen Cipher,

output xᵢ;

.......................... ...until... ... ... ... ... ... ... ... ... ... ... ... ... ....
Encrypt r_{N-1} using SK_{N-1} on Sender's the (N−1)^{th} implementation of the Chosen

Cipher, output x_{N-1};

Encrypt M⊕r₁⊕r₂...⊕r_{N-1} using SK_{N} on the Sender's N^{th} implementation of the

Chosen Cipher, output x_{N}.

When the Chosen Cipher is an asymmetric cipher:

Encrypt r₁ using PubK₁ on the Sender's 1^{st} implementation of the Chosen Cipher,

output x₁;

................... ...continue the following pattern... ... ... ... ... ... ... ... ... .....

Encrypt rᵢ using PubKᵢ on the Sender's i^{th} implementation of the Chosen Cipher,

output xᵢ;

.......................... ...until... ... ... ... ... ... ... ... ... ... ... ... ... ....

Encrypt r_{N-1} using PubK_{N-1} on the Sender's (N−1)^{th} implementation of the Chosen

Cipher, output x_{N-1};

Encrypt M⊕r₁⊕r₂...⊕r_{N-1} using PubK_{N} on the Sender's N^{th} implementation of the

Chosen Cipher, output x_{N}.

The Sender sends all xᵢ (1≤i≤N) to the Receiver.

In the step 540 of United-C, the Receiver will perform decryption on the xᵢ using the SKᵢ if the Chosen Cipher is a symmetric cipher, or PriKᵢ if the Chosen Cipher is an asymmetric cipher, on the Receiver's i^{th} implementation of the Chosen Cipher. Similar to the Sender, the Receiver can choose his own set of N implementations of the Chosen Cipher based on the evaluation on the potential threats on the Receiver's end. The N implementations used by the sender DO NOT need to be the same as the N implementations used by the receiver. If the Chosen Cipher is a symmetric cipher:

Decrypt x₁ using SK₁ on the Receiver's 1^{st} implementation of the Chosen Cipher,

output r₁;

................... ...continue the following pattern... ... ... ... ... ... ... ... ... .....
Decrypt xᵢ using SKᵢ on the Receiver's i^{th} implementation of the Chosen Cipher,

output rᵢ;

.......................... ...until... ... ... ... ... ... ... ... ... ... ... ... ... ....
Decrypt x_{N-1} using SK_{N-1} on the Receiver's (N−1)^{th} implementation of the Chosen

Cipher, output r_{N-1};

Decrypt x_{N} using SK_{N} on the Receiver's N^{th} implementation of the Chosen Cipher,

output M⊕r₁⊕r₂...⊕r_{N-1}.

When the Chosen Cipher is an asymmetric cipher:

Decrypt x₁ using PriK₁ on the receiver's 1^{st} implementation of the Chosen Cipher,

output rᵢ;

................... ...continue the following pattern... ... ... ... ... ... ... ... ... .....
Decrypt xᵢ using PriKᵢ on the Receiver's i^{th} implementation of the Chosen Cipher,

output rᵢ;

.......................... ...until... ... ... ... ... ... ... ... ... ... ... ... ... ....
Decrypt x_{N-1} using PriK_{N-1} on the Receiver's (N−1)^{th} implementation of the Chosen

Cipher, output r_{N-1};

Decrypt x_{N} using PriK_{N} on the Receiver's N^{th} implementation of the Chosen Cipher,

output M⊕r₁⊕r₂...⊕r_{N-1}.

In the step 550 of United-C, the Receiver can recover the original message M by taking Exclusive-OR (XOR) operations on r₁, r₂, . . . , and M⊕r₁⊕r₂ . . . ⊕r_{N-1}, that is:

r₁⊕r₂ . . . βr_{N-1}⊕(M⊕r₁⊕r₂ . . . ⊕r_{N-1})=r₁⊕r₁⊕r₂⊕r₂⊕ . . . ⊕r_{N-1}⊕r_{N-1}⊕M=M

Note that, if the Sender used some other reversible function F the Receiver will always be able to recover M by applying the all random numbers and the output of F.

Security Enhancement. United-C improves the resistance to side-channel attacks over the existing solution. In the existing solution, the Sender encrypts M only once, which uses one key, and one specific implementation of the Chosen Cipher. However, there is no perfect implementation that is resistant to all existing and future side-channel attacks. A successful attack against this specific implementation will reveal M.

In United-C, M is obfuscated into N messages, which are then encrypted or decrypted using up to N different implementations of the Chosen Cipher. An attack won't be successful unless ALL N implementations are broken. The proof for the encryption is shown below. The proof for the decryption or using other operations is similar.

Assume the Attacker can break all-but-1 implementations that are used by the Sender. The only implementation that remains unbroken could be either the N^{th} implementation that encrypts M⊕r₁⊕r₂ . . . ⊕r_{N-1}, or one of the implementations that encrypts a random number. If it is the former case, M remains secure for sure since all broken implementations do not even touch M. If it is the latter case, let us assume the random number encrypted by the unbroken implementation is rₓ. rₓ remains unknown to the Attacker. By manipulating all the rest random numbers as well as M⊕r₁⊕r₂ . . . ⊕r_{N-1}, the best that the Attacker can obtain is M⊕rₓ. However, without knowing rₓ, the Attacker can't recover M out of M⊕rₓ.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact examples that has been described above and illustrated in the accompanying drawings, and that various modifications and changes may be made without departing from the scope thereof. It is intended that the scope of the present disclosure only be limited by the appended claims.

What is claimed is:

1. A communication method using a symmetric cipher, comprising:
creating, by a sender, at least one random message using at least one random number;
obtaining, by the sender, an obscured message by taking bit-wise Exclusive-OR (XOR) operations on an original message and the at least one random message;
obtaining, by the sender, at least one encrypted random message by encrypting the at least one random message using at least one first secret key and using at least one first implementation of the symmetric cipher, wherein each of the least one first secret key is independent from each other and each of the at least one first implementation is unique;
obtaining, by the sender, an encrypted obscured message by encrypting the obscured message by using a second secret key on a second implementation of the symmetric cipher, wherein each of the at least one first secret key and the second secret key are independent from each other, and wherein each of the at least one first implementation is different from the second implementation such that the at least one first implementation and the second implementation have different resistances to the same side channel attacks; and
sending, by the sender, the at least one encrypted random message and the encrypted obscured message to the receiver.

2. The method of claim 1, further comprising:
receiving, by the receiver, the at least one encrypted random message and the encrypted obscured message from the sender;
obtaining, by the receiver, decrypted messages by decrypting each of the at least one encrypted random message and the encrypted obscured message with a corresponding secret key using a unique implementation of the symmetric cipher; and
recovering the original message by taking Exclusive-OR (XOR) operations on all decrypted messages.

3. The method of claim 1, further comprising:
negotiating a total number of the at least one random message between the sender and the receiver.

4. The method of claim 3, further comprising:
adjusting the total number of the at least one random message according to a preset rule between the sender and the receiver.

5. The method of claim 1, further comprising:
selecting different sets of implementations on at least one of the sender or the receiver.

6. A computer system using a symmetric cipher, comprising:
a sender configured to:
obtain an obscured message by obscuring an original message with a plurality of random numbers;
encrypt each of the plurality of random numbers and the obscured message by using an independent secret key, and on one of the sender's unique implementations of the symmetric cipher; and
send the encrypted random numbers and the encrypted obscured message to a receiver.

7. The computer system of claim 6, wherein the sender obtains the obscured message using the plurality of random numbers by performing acts comprising:
creating, by a sender, N−1 messages using N−1 random numbers, wherein N is a positive integer greater than 1; and
creating, by the sender, the N^{th} message using the original message and the N−1 random numbers,
wherein N is negotiated between the sender and receiver before obscuring the message.

8. The computer system of claim 7, wherein the sender creates the N^{th} message using the original message and the N−1 random numbers by performing acts comprising:
obtaining the obscured message by using a reversible function on the original message and the plurality of random numbers.

9. The computer system of claim 6, wherein N is selected by the receiver and the sender based on a frame index.

10. The computer system of claim 6, wherein N is selected and adjusted based on a first location of the receiver and a second location of the sender.

11. The computer system of claim 6, wherein encrypting each of the N messages to be encrypted by an independent secret key comprise:
outputting xᵢ by encrypting each of N−1 random numbers (rᵢ) using SKᵢ on the sender's i^{th} implementation of the symmetric cipher, wherein i is greater than or equal to 1 and less than N; and
outputting x_{N} encrypting M⊕r₁⊕r₂ . . . ⊕r_{N-1} using SK_{N} on the sender's N^{th} implementation of the symmetric cipher.

12. The computer system of claim 6, wherein the receiver is configured to decrypt each of the N messages by using a corresponding secret key using a unique implementation of the symmetric cipher.

13. A method for using an asymmetric cipher, comprising:
creating, by a sender, N−1 messages using N−1 random numbers, wherein N is a positive integer greater than 1; and
creating, by the sender, the N^{th} message using the original message and the N−1 random numbers; and
obtaining N encrypted messages by encrypting each of the N messages using an independent public key issued by a receiver, and on one of the sender's unique implementations of the asymmetric cipher.

14. The method of claim 13, further comprising:
sending the N encrypted messages to the receiver.

15. The method of claim 14, further comprising:
receiving the N encrypted messages at the receiver; and
obtaining N decrypted messages by decrypting each of the N encrypted messages using a private key corresponding to the public key used in the encryption process, and on one of the receiver's unique implementations of the asymmetric cipher.

16. The method of claim 14, wherein creating the N^{th} message using the original message and the N−1 random numbers comprises:
obtaining the obscured message by using a reversible function on the original message and the plurality of random numbers.

17. The method of claim 14, wherein N is selected by the receiver and the sender based on a frame index.

18. The method of claim 14, wherein N is selected and adjusted based on a first location of the receiver and a second location of the sender.

19. The method of claim 14, wherein encrypting each of the N messages to be encrypted by an independent public key comprise:
outputting xᵢ by encrypting each of N−1 random numbers (rᵢ) using PubKᵢ on the sender'i^{th} implementation of the asymmetric cipher, wherein i is no less than 1 but less than N; and
outputting x_{N} encrypting M⊕r₁⊕r₂ . . . ⊕r_{N-1} using PubK_{N} on the sender's N^{th} implementation of the asymmetric cipher.

20. The method of claim 14, wherein the receiver is configured to decrypt each of the N messages by using a corresponding private key using a unique implementation of the asymmetric cipher.
